(19) United States
(12) Patent Application Publication
(10) Pub. No.: US 2006/0260281 A1
(43) Pub. Date: Nov. 23, 2006

(54) Cleaning device for dust collector

(75) Inventor: Tien-Yu Peng, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Oav Equipment & Tools, Inc., Taichung Hsien (TW)

(21) Appl. No.: 11/184,812

(22) Filed: Jul. 20, 2005

(30) Foreign Application Priority Data
May 19, 2005 (TW) 94208158

(51) Int. Cl. B01D 46/04

(52) U.S. Cl. 55/295

(57) ABSTRACT

A cleaning device is used in a dust collector having a body and a tubular filter set mounted in the body for cleaning the inside wall of the tubular filter set of the dust collector. The cleaning device includes a first shaft transversely pivoted to the body of the dust collector and provided with a driving member, a second shaft longitudinally pivoted to the body of the dust collector and provided with a driven member coupled to the driving member of the first shaft, and elastic scrapers mounted on the second shaft and contacted with the inside wall of the tubular filter set for removing dust from the inside wall of the tubular filter set upon rotary motion of the second shaft subject to the rotation of the first shaft.

### BACKGROUND OF THE INVENTION

1. Field of the Invention

The present invention relates to a dust collector and more particularly, to a cleaning device for use in a dust collector.

2. Description of the Related Art

In an industrial fabrication place where waste particles or dust is produced, a dust collector will be used to collect waste particles and dust. A dust collector for this purpose generally comprises a body, a tubular filter set surrounding the body, and a cleaning device. When air flow passes through the filter set, the filter set removes waste particles and dust from the air flow, preventing dispersion of waste particles and dust in the surroundings. After accumulation of a certain amount of waste particles and dust in the inside wall of the filter set, the cleaning device is operated to remove the accumulated waste particles and dust from the inside wall of the filter set to the outside of the dust collector. When cleaning the filter set, the operator must hold the handle of the cleaning device and move the cleaning device over the inside wall of the filter set again and again to remove accumulated waste particles and dust from the inside wall of the filter set. This cleaning operation requires much effort.

### SUMMARY OF THE INVENTION

The present invention has been accomplished under the circumstances in view. It is one object of the present invention to provide a cleaning device for a dust collector, which can easily be operated with less effort to effectively remove dust from the filter set of the dust collector.

To achieve this object of the present invention, the cleaning device, which is used in a dust collector having a body and a tubular filter set mounted in the body for cleaning the tubular filter set of the dust collector, comprises a first shaft, a second shaft and at least one elastic scraper. The first shaft is pivotally mounted in the body of the dust collector and provided with a driving member located inside the tubular filter set. The second shaft is pivotally mounted in the body of the dust collector and provided with a driven member coupled to the driving member of the first shaft for enabling the second shaft to be rotated relative to the tubular filter set by the first shaft. The at least one elastic scraper is respectively fastened to the second shaft and contacted with an inside wall of the tubular filter set for moving over the inside wall of the tubular filter set upon rotation of the second shaft relative to the tubular filter set. BRIEF DESCRIPTION OF THE DRAWINGS

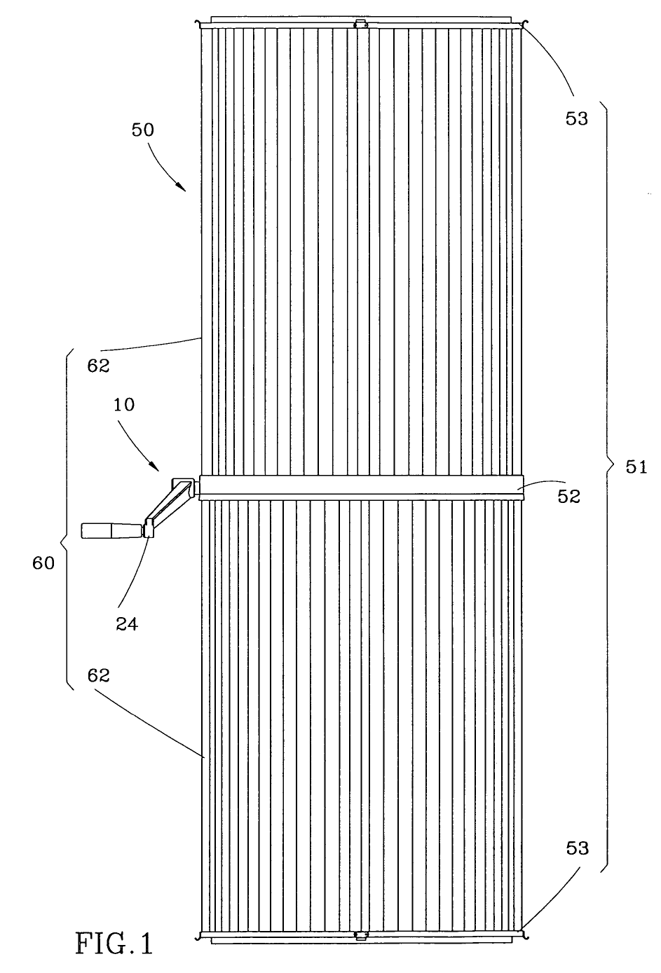

FIG. 1 is a front view of a preferred embodiment of the present invention.

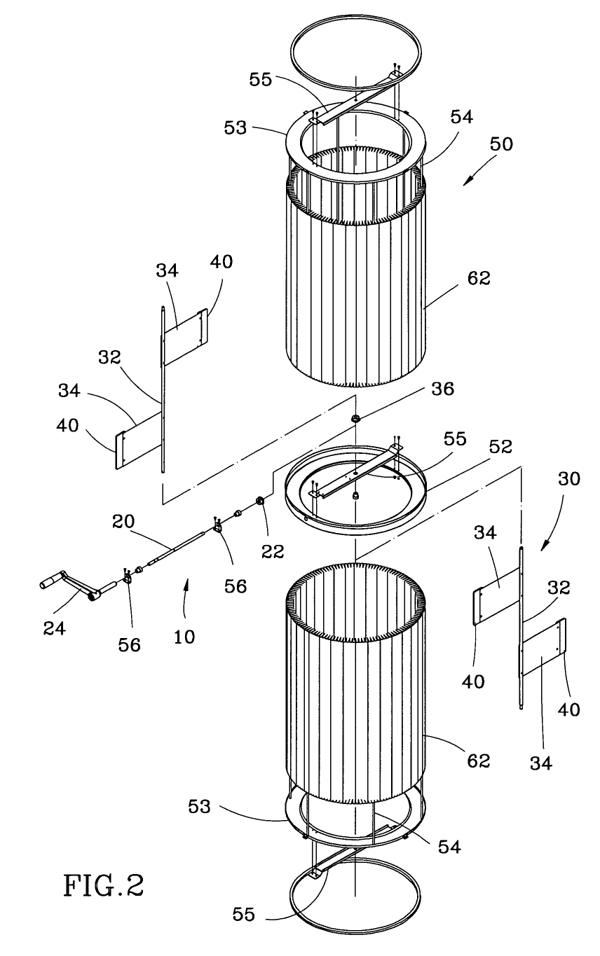

FIG. 2 is an exploded view of the preferred embodiment of the present invention.

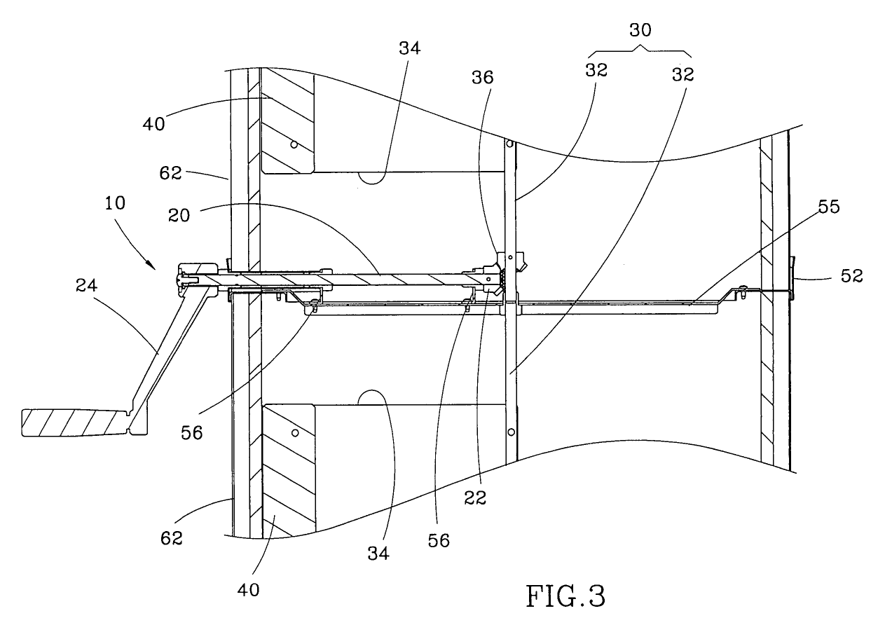

FIG. 3 is a sectional view in an enlarged scale of a part of the present invention, showing the connection between the first shaft and the second shaft.

### DETAILED DESCRIPTION OF THE INVENTION

Referring to FIGS. 1 and 2, a dust collector 50 is shown comprised of a body 51 and a filter set 60. The body 51 comprises a first rim member 52, two second rim member 53, a plurality of connecting rod members 54, and three support members 55. The two second rim members 53 are coaxially spacedly connected to the first rim member 52 at two sides by the connecting rod members 54. The support members 55 are respectively fastened to the first rim member 52 and the second rim members 53. The filter set 60 comprises two tubular filters 62 respectively mounted around the body 51 at different elevations between the second rim members 54 and the first rim member 52, thereby forming with the body 51 a cylindrical profile.

Referring to FIG. 3 and FIG. 2 again, a cleaning device 10 is installed in the dust collector 50, comprising a first shaft 20, a second shaft 30, and four scrapers 40. The first shaft 20 has a driving member, for example, a driving bevel gear 22 provided at one end thereof, and a crank handle 24 provided at the other end thereof. The first shaft 20 is transversely (radially) inserted through the first rim member 52 and supported in two axle bearings 56 at the support member 55 at the first rim member 52 for free rotation, keeping the driving bevel gear 22 suspending inside the filter set 60.

The second shaft 30 is comprised of two shaft elements 32 connected in line. Each shaft element 32 has two holder plates 34 symmetrically disposed at two sides near two distal ends. One shaft element 32 has one end provided with a driven member, for example, driven bevel gear 36. The second shaft 30 is coaxially inserted through the support members 55 at the rim members 52 and 53 of the body 51 and set at right angles relative to the first shaft 20, keeping the driven bevel gear 36 meshed with the driving bevel gear 22. When rotating the first shaft 20 relative to the body 51, the driving bevel gear 22 drives the driven bevel gear 36 to rotate the second shaft 30.

The scrapers 40 are made of elastic material and respectively fastened to the holder plates 34 at the shaft elements 32 of the second shaft 30 and pressed on the inside walls of the tubular filters 62 of the filter set 60. During rotary motion of the second shaft 30 subject to the rotation of the first shaft 20, the scrapers 40 are moved over the inside walls of the tubular filters 62 of the filter set 60.

When the user wishes to clean the filter set 60 of the dust collector 50, operate the crank handle 24 to rotate the first shaft 20 and to further cause the driving bevel gear 22 to rotate the driven bevel gear 36 and the second shaft 30, and therefore the scrapers 40 are respectively moved over the inside walls of the tubular filters 62 of the filter set 60 to remove dust from the inside walls of the tubular filters 62 of the filter set 60. Therefore, cleaning the filter set 60 is quite simple.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A cleaning device used in a dust collector having a body and a tubular filter set mounted in the body for cleaning the tubular filter set of the dust collector, the cleaning device comprising:
a first shaft pivotally mounted in said body of said dust collector and provided with a driving member located inside said tubular filter set;
a second shaft pivotally mounted in said body of said dust collector and provided with a driven member coupled to said driving member of said first shaft for enabling said second shaft to be rotated relative to said tubular filter set by said first shaft; and
at least one elastic scraper respectively fastened to said second shaft and contacted with an inside wall of said tubular filter for moving over the inside wall of said tubular filter set upon rotation of said second shaft relative to said tubular filter set.

2. The cleaning device as claimed in claim 1, wherein said driving member and said driven member are bevel gears meshed with each other.

3. The cleaning device as claimed in claim 1, wherein said first shaft and said second shaft are substantially arranged perpendicularly.

4. The cleaning device as claimed in claim 1, wherein said first shaft is provided a crank handle suspending outside said dust collector for rotating said first shaft.

5. The cleaning device as claimed in claim 1, wherein said second shaft comprises at least one holder plate on which said at least one scraper is respectively mounted.
